(19) United States
(12) Patent Application Publication
(10) Pub. No.: US 2022/0012800 A1
(43) Pub. Date: Jan. 13, 2022

(54) SYSTEM AND METHOD FOR ORDERING FOOD

(71) Applicant: Nibble Technology, LLC, New York, NY (US)

(72) Inventors: Ishwari Nitin Bendre, New York, NY (US); Jonathan Roy Poulter, New York, NY (US); Murtuza Bengali, New York, NY (US)

(21) Appl. No.: 17/367,983

(22) Filed: Jul. 6, 2021

Related U.S. Application Data
(60) Provisional application No. 63/048,920, filed on Jul. 7, 2020.
(60) Provisional application No. 63/210,107, filed on Jun. 14, 2021.

(51) Int. Cl. G06Q 30/06; G06Q 50/12

(52) U.S. Cl. CPC G06Q 30/0643; G06Q 30/0631; G06Q 50/12; G06Q 30/0639; G06Q 30/0619

(57) ABSTRACT

A system is disclosed. The system has a food ordering module, comprising computer-executable code stored in non-volatile memory and a processor. The food ordering module and the processor are configured to receive order generation input from a user, identify a plurality of establishments based on the order generation input, select an establishment from the plurality of establishments, transfer data of a menu of the establishment into a standardized menu format, generate a hypothetical food order based on the standardized menu format, and display the hypothetical food order to the user via a user device.

This application claims the benefit of the following provisional applications 63/048,920 filed Jul. 7, 2020, and 63/210,107 filed Jun. 14, 2021, the entire disclosure of each of which is incorporated herein by reference.

### TECHNICAL FIELD

The present disclosure is directed to a system and method for order generation, refinement, and order placement, and more particularly, to a system and method for creating a food order (e.g., food order generation, refinement, and order placement).

### BACKGROUND OF THE DISCLOSURE

Conventional food ordering systems typically involve having users narrow down a large number of cuisines, establishments, and dishes to decide on a food order, which involves a large number of independent decisions to be made by the user, potentially leading to choice paralysis and sub-optimal outcomes. Users typically determine how much food to order for themselves or their party based on little or no portion information. Conventional food ordering systems often involve users going through a menu and recognizing items that do not adhere to their own dietary restrictions or preferences (e.g., vegetarianism). Also, existing systems provide very little insight into a user's opinions on individual dishes, as users do not interact with dishes they do not want.

During order placement, conventional systems or services may detect confirmatory information regarding what a customer might like, but may have and/or gain little or no information regarding foods that users do not like (a unary piece of information), thereby building merely a limited profile of a client. This creates disadvantages for both food ordering services as well as establishments (e.g., restaurants, grocery stores, online ordering, and/or any other suitable source for obtaining food) that may find this type of information useful.

Conventional systems typically do not take into consideration health goals of the user (e.g. target caloric intake) into consideration to suggest a more appropriate order. These typical systems also often involve little surprise, excitement, or novelty in food ordering. Conventional systems expect a user to know their order to some degree at the beginning of the ordering process, which effectively reduces food ordering choices to what the user knows to exist, which may restrict food ordering options, as a user could not explore all possible options and combinations.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a system. The system includes a food ordering module, comprising computer-executable code stored in non-volatile memory and a processor. The food ordering module and the processor are configured to receive order generation input from a user, identify a plurality of establishments based on the order generation input, select an establishment from the plurality of establishments, transfer data of a menu of the establishment into a standardized menu format, generate a hypothetical food order based on the standardized menu format, and display the hypothetical food order to the user via a user device.

In another exemplary aspect, the present disclosure is directed to a method. The method includes receiving order generation input, which excludes data of food type and food items, from a user, identifying a plurality of establishments based on the order generation input, selecting an establishment from the plurality of establishments, transferring data of a menu of the establishment into a standardized menu format, generating a hypothetical food order based on the standardized menu format, and displaying the hypothetical food order, which includes data of food type and food items, to the user via a user device.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 illustrates an exemplary process and system of at least some exemplary embodiments of the present disclosure;

FIG. 2 illustrates an exemplary process of at least some exemplary embodiments of the present disclosure;

FIG. 3 illustrates an exemplary process of at least some exemplary embodiments of the present disclosure;

FIG. 4 is a schematic illustration of an exemplary computing device, in accordance with at least some exemplary embodiments of the present disclosure;

FIG. 5 is a schematic illustration of an exemplary network, in accordance with at least some exemplary embodiments of the present disclosure; and

FIG. 6 is a schematic illustration of an exemplary network, in accordance with at least some exemplary embodiments of the present disclosure.

### DETAILED DESCRIPTION AND INDUSTRIAL APPLICABILITY

The exemplary disclosed system and method may be an algorithmic food order generation, refinement, and order placement system. The exemplary disclosed system and method may be used in ordering any food (e.g., any substance that people or animals may eat or drink such as solids and/or liquids that may provide sustenance, for nutrition, and/or enjoyment). For example, food may include solid food and/or beverages. The exemplary disclosed system and method may provide an automated framework (e.g., a framework for an automated approach) for food order generation, refinement, and placement or any subset of these actions. The exemplary disclosed system and method may allow for minimal involvement from an end user, which may reduce or substantially eliminate a user's choice paralysis and may enhance satisfaction of food ordering, consumption, and dining for a user.

The exemplary disclosed system and method may capture a user's perception of relationships between foods and individual dishes, based on information available to the system, using a mixture of traditional or machine learning and artificial intelligence techniques (e.g., the user has indicated or has been observed to have a strong preference for ‘samosa’, typically an Indian triangular savory pastry filled with vegetable or meat, which may be linked to a ‘sambosa’, also an Ethiopian delicacy). In at least some exemplary embodiments, the exemplary disclosed system and method may identify, determine, and/or store relationships between different types of foods by using any suitable technique such as, for example, text vectorization, clustering, and/or any other suitable technique for determining relationships (e.g., similarities) between dishes, menu sections, and/or establishments. For example, the exemplary disclosed system and method may identify relationships and similarities between foods that may at first glance to a user appear different (e.g., certain Indian foods or dishes that may actually be relatively similar to other food types such as certain Ethiopian food or dishes). For example, when the exemplary disclosed system and method includes data (e.g., user input) that a user enjoyed a given type of French food at a French establishment, and has also identified a relationship between that French food and a given type of Brazilian food, the exemplary disclosed system and method may recommend that given type of Brazilian food to the user when the user visits a Brazilian establishment.

The exemplary disclosed system and method may incorporate desired variables (e.g., extra variables) into recommendations such as weather and time of day based on the exemplary processes disclosed herein (e.g. the exemplary disclosed system may fetch weather information from an external source for the user location, determine that it is raining, and use this to suggest ‘Ramen’, or another food the user may consider favorable on an inclement weather day, as one of the cuisine options).

The exemplary disclosed system and method may determine a maximum that a user may be willing to spend per person on food based on user input and/or the exemplary processes disclosed herein and provide recommendations accordingly (e.g. a user may explicitly input a maximum they would like to spend).

The exemplary disclosed system and method may allow the user to pre-select a specific continent, and filter cuisine and establishment (e.g., restaurants, grocery stores, online ordering, and/or any other suitable source for obtaining food) choices based on the selected continent. Alternatively, it could take into account certain festivals and display items accordingly (e.g., Indian food order for Diwali).

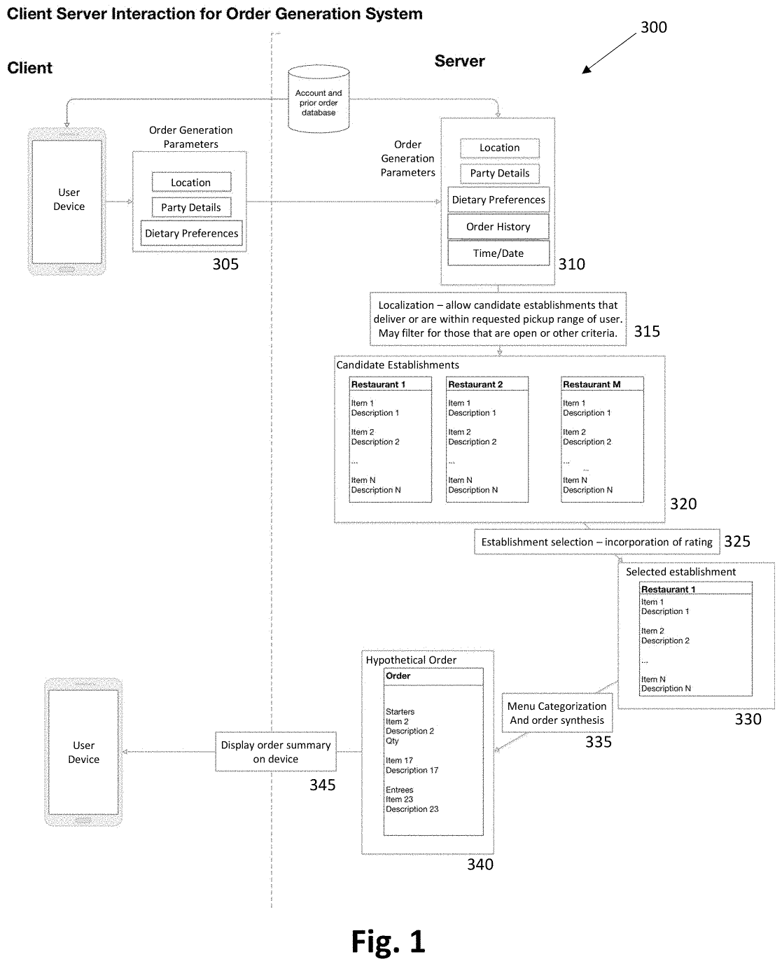

FIG. 1 illustrates an exemplary disclosed process for initial order generation. A user (e.g., a client) may provide input data (e.g., minimal inputs) to trigger a full filtering and order generation process for example as illustrated in FIG. 1 (and as further described below regarding FIG. 1). In at least some exemplary embodiments, the exemplary disclosed system and method may provide a user with an initialization set. For example, the exemplary disclosed system and method may create an initialization set for a user based on user input (e.g., via any suitable user interface for example as described herein), any suitable data source including user data (e.g., third party applications that a user may link or to which a user may provide or allow access such as Grubhub or Yelp), and/or any other suitable data source. The exemplary disclosed system and method may use the user data to initialize a profile for the user, which may create more accurate recommendations when a user begins to use the exemplary disclosed system and method (e.g., on a startup of the exemplary disclosed system and method).

The exemplary disclosed system and method may return a generated order and next actions to the user. The exemplary disclosed system and method may generate an order recommendation without querying the user to make food ordering choices (e.g., any choices). In at least some exemplary embodiments, the user may provide state or status information as input (e.g., instead of food selection). For example, the user may provide information describing his or her state or status (e.g., information including location data, data regarding his or her party, dietary preferences, and any other suitable status data). Some or all of the state or status information may be stored in the system's storage and/or provided by a user's device (e.g., location data) In response to the state or status information, the exemplary disclosed system may return an actionable order (e.g., an actionable food order that the user may use to order food or a recommendation of what to order during a suggested establishment (e.g., restaurants, grocery stores, online ordering, and/or any other suitable source for obtaining food) visit).

The exemplary disclosed system and method may filter menu items based on item title and/or item description (e.g., halal, vegetarian, gluten free, or vegan). Menu items that do not match dietary criteria may be filtered out by the exemplary disclosed system. (e.g., the user may have selected ‘No Pork’, then all dishes with ‘ham’, ‘prosciutto’, ‘pancetta’ etc. in either the title or the description of the dishes may be removed from the recommendation). The exemplary disclosed system may infer an item's ingredients based on information other than matching ingredients directly in the title or description (e.g., by using external or mined knowledge such as, in the absence of any other information, a cheeseburger is likely to contain a beef patty). The exemplary disclosed system and method may use menu names, descriptions, ingredients, and/or items provided across available establishment data such as restaurant, grocery store, and online ordering data (e.g., that may be stored in a storage of the exemplary disclosed system for example as described herein) to interpolate item attributes.

The exemplary disclosed system may provide (e.g., introduce) sections such as synthetic menu sections or hierarchies, for a range of purposes, including standardizing an order's display to a user. For example, the exemplary disclosed system may provide a plurality of synthetic menu sections and/or hierarchies that may provide an organization or template for standardizing different types of menus. For example, information from various formats and layouts of menus may be transferred into a standardized menu format of the exemplary disclosed system, so that differently-formatted third party menus and forms may be put into the standardized form of the exemplary system to be more easily compared to each other. For example, the exemplary disclosed system may introduce classifications to information provided by establishments (e.g., restaurants, grocery stores, online ordering, and/or any other suitable source for obtaining food). The exemplary disclosed system and method may transform an originally-entered menu of a given establishment (e.g., restaurants, grocery stores, online ordering, and/or any other suitable source for obtaining food) into a standardized structure. The standardized structure may include course categorization such as, for example, Appetizers, Sides, Entrees, Desserts, and Drinks.

The exemplary disclosed system and method may process data associated with some or substantially all involved establishments, in the aggregate, in determining or creating a standardized structure (e.g., standardized menu format). The exemplary disclosed system and method may perform course categorization (e.g., including the exemplary categorization for example described herein), dietary restriction identification, and/or other ranking and/or classification online (e.g., while processing a user request), and/or during a precomputation step (e.g., an offline precomputation step). Some or substantially all establishments may be considered in aggregate, which may improve a quality or effectiveness of the ranking and/or classification. For example, it may be difficult to determine that a given food includes a given ingredient. When establishments are considered in the aggregate, though, it may be determined that the given food includes the given ingredient. For example, it may be difficult to determine that a certain type of lasagna includes beef and therefore should not be shown to a user who is identified by the exemplary system and method as a vegetarian. When considered within the scope of lasagna offerings in the aggregate across establishments, the exemplary disclosed system and method may determine (e.g., infer with no other new information for example using exemplary disclosed machine learning operations) the certain type of lasagna indeed includes beef and accordingly should not be recommended to a user identified as a vegetarian.

The exemplary disclosed system may also create a plurality of user profiles for a given user (e.g., a first profile including data of long-term likes and/or dislikes of the given user, and a second profile including data of what the given user may like or dislike on a given day or as short-term likes and/or dislikes). For example, a long term preference (e.g., data of the first profile) may indicate that the user does not like spicy food. The system may therefore apply a low weighting to spicy food (e.g., a low weight for recommendations of spicy food). Alternatively for example, a user may not like to have spicy food on a given day, which may be included on the second or short-term profile. Both of these flavor profiles may be included in an item selection algorithm of the exemplary disclosed system and method. Further for example, if a user in general likes French cuisine, such food may be included in the first profile and the second profile as a “like” data, but if that user ate French cuisine the day before then French cuisine may be listed on the second profile as a short-term “dislike.” For example, order generation parameters may include location, party details (e.g. party size), dietary preferences, order history, time and date, weather, and/or any other suitable data. The exemplary disclosed system and method may use the first and second profile data in conjunction with the order generation parameters to determine food ordering output. In at least some exemplary embodiments, the exemplary disclosed system and method may rank proposed food or dish choices for a user based on the user's past ordering selections and/or the user's past ordering selections at that particular establishment or type of establishment.

The exemplary disclosed system may consider the user profiles of multiple users in a group order and present an order recommendation based on multiple preference profiles and multiple order histories. In at least some exemplary embodiments, the exemplary disclosed system may use the order history of many users of the system at a given current establishment (and/or other establishments) to identify relationships between foods and may use these identified relationships as an input to provide a recommendation. For example, generating a hypothetical food order may be based on identified relationships between foods that are based on order histories of a plurality of other users.

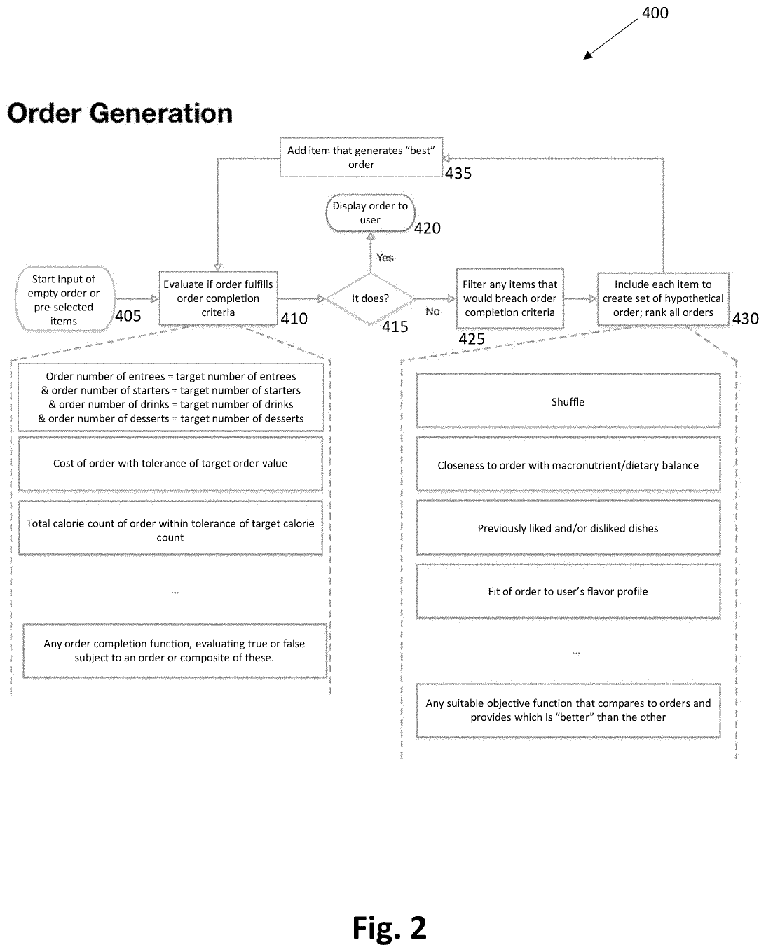

FIG. 2 illustrates an exemplary disclosed process for generating an order from a filtered menu, which may be done without user interaction. FIG. 2 illustrates exemplary steps of the order generation process (e.g., and as further described below regarding FIG. 2). The exemplary disclosed order generation process may include sizing an order and selecting items to constitute the order.

Sizing of an order may be based on parameters such as party size and dish weighting. For example, sizing may be determined by the below exemplary equations, where party size is represented by “p”:

Number of appetizers: floor((p−1)/2)+1

Number of entrees: floor(p/2)+1

Number of desserts: floor((p−1)/2)+1

Number of drinks: p

(e.g. for a party size of five individuals, the exemplary disclosed system may recommend 3 appetizers, 3 entrees, 3 desserts and 5 drinks). The exemplary disclosed system and method may perform the exemplary disclosed sizing based on processing data including information of a user's order history for a given establishment or order history of other patrons of the given establishment and/or other establishments that may be similar to or related to the given establishment. The exemplary disclosed system and method may identify relationships and similarities between establishments using techniques that may be similar to those described above regarding relationships and similarities between foods.

In at least some exemplary embodiments, selecting items to constitute an order may include the steps illustrated in FIG. 2. For example, the exemplary disclosed system and method may split up elements of an order by menu segment and then rank the elements.

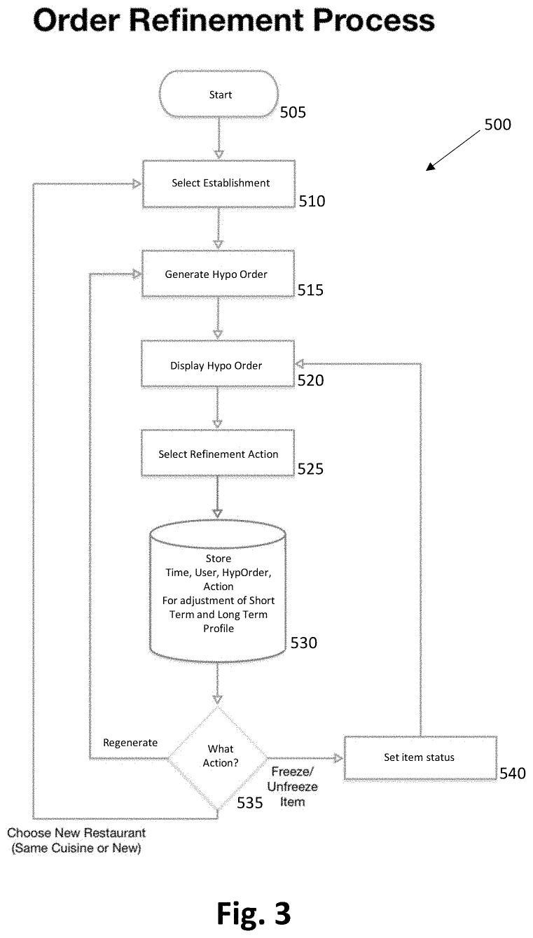

FIG. 3 illustrates an exemplary disclosed order refinement process (e.g., and as further described below regarding FIG. 3). The exemplary disclosed order refinement process may include a user interaction methodology. For example, a user may provide input indicating “like” and/or “dislike” of items. The exemplary disclosed order refinement process may follow the order generation process illustrated in FIG. 2. The exemplary disclosed order refinement process may include adding and/or removing specific items. Additionally, the exemplary disclosed order refinement process may utilize menu histories, trained models and predictive analytics to refine weight (e.g., in a new order generation), and/or adjust weights in categories to indicate that a given dish was skipped and not liked. Also, the exemplary disclosed order refinement process may involve “freezing” an item. “Frozen” items may not change between refreshes of a display of a user interface (e.g., if a user freezes ‘jalapeno mac and cheese’ and then refreshes the menu for the same establishment such as restaurants, grocery stores, online ordering, and/or any other suitable source for obtaining food, it may change substantially all the other items in the newly generated order but the ‘frozen’ one). For example, the exemplary disclosed system and method may provide for a created order to be saved or “frozen” and then for new dishes to be subsequently built around the saved or frozen items. Exemplary items that are “frozen” may influence weightings of flavor preferences (influencing future item recommendations from the present or other establishments) by updating an existing predictive model (e.g., may weight other items based on flavor, e.g., flavor similarity).

The exemplary disclosed order refinement process may include removing an item. Items that are removed may influence the weight of future item choices (e.g., similar or related items such as similar or related flavor items). For example, other items may be avoided because of dislike of the removed item.

The exemplary disclosed order refinement process may include adding an item. The exemplary disclosed system and method may increase the size of an order and/or may automatically select a “best item” to fit into the new slot for example as described herein.

The exemplary disclosed order refinement process may also include a capability to change a selected or recommended establishment (e.g., restaurants, grocery stores, online ordering, and/or any other suitable source for obtaining food) and/or cuisine. For example, the exemplary disclosed system and method may change an establishment (e.g., restaurants, grocery stores, online ordering, and/or any other suitable source for obtaining food) within a selected cuisine type or trigger another randomized search for both the cuisine and an establishment.

The exemplary disclosed system and method may provide for refinement rules for refining a food order selection (e.g., if a user rejects two spicy dishes, then another spicy dish may not be shown to the user).

In at least some exemplary embodiments, the exemplary disclosed system and method may use a potentially iterative process to add items to a potential order by ranking some or substantially all items based on how much a user may approve of the resulting order after inclusion of the item along with the already included items.

In at least some exemplary embodiments, the processes exemplary disclosed system and method may be directed to providing users with satisfaction relating to the food that is selected. For example, optimizing user satisfaction may be the objective of the exemplary disclosed system and method.

In at least some exemplary embodiments, the exemplary disclosed system and method may recommend a dish (e.g., via a notification) to a user without an explicit client request. The request may be provided to the user at any desired time or frequency (e.g., before a user may be hungry based on the time of the last meal). The exemplary disclosed system and method may operate based on a module stored on a user's device and/or stored in a network.

In at least some exemplary embodiments, the exemplary disclosed system and method may vary section or course categorization based on country, a user's desire for formality (e.g., introduction of a fish course), and/or any other suitable criteria.

In at least some exemplary embodiments, the exemplary disclosed system and method may incorporate any suitable criteria into the ranking and order sizing process. For example, a cost approximation may be used. Establishments (e.g., restaurants, grocery stores, online ordering, and/or any other suitable source for obtaining food) may be classified using criteria such as “cheap,” “moderate,” “expensive,” or “very expensive,” which may be based in part on country or geography. Based on this exemplary cost approximation, an expected spend per person may be derived or determined. The system may use party size multiplied by a determined spend per person to calculate a limit for selecting items from a menu (e.g., the user enters a $50 limit spend per person with a party size of five people, the exemplary disclosed system would ensure that the total of all the courses does not surpass a total of $250 (5×$50) or a maximum of $262.50, with a tolerance of 5%).

In at least some exemplary embodiments, caloric approximation may also be used for order sizing). Items may be classified by their estimated caloric value and/or by other criteria. The exemplary disclosed system and method may then select items up to a target caloric threshold (e.g., possibly sourced from a USDA recommendation or similar authority) or above or below the target caloric threshold by an acceptable tolerance (e.g., user inputs they are looking to consume not more than 1200 calories which the recommendation engine can use to curate the menu such that the total of all the dishes do not surpass that value within a tolerance of 5%). After ordering, the exemplary disclosed system and method may query the user for feedback as to whether too much or too little food was ordered, and the collected data may be used by the exemplary disclosed system and method to adjust weights of dishes (e.g., quantity) in the future (e.g., including “shared” dishes).

In at least some exemplary embodiments, the exemplary disclosed system and method may provide feedback information or data to a user that provides criteria, reasons, and/or information regarding the methodology of why a particular food (e.g., a dish) was selected for the user. For example, the exemplary disclosed system and method may provide information regarding the exemplary disclosed algorithm steps and exemplary disclosed criteria regarding food selection. The exemplary disclosed system and method may display this feedback information or data via any suitable user device such as, for example, the exemplary disclosed user device. For example, the exemplary disclosed system and method may provide data to a user regarding temporal or weather criteria (e.g., a food was selected based on the day being hot or cold or based on a certain time of day), data describing how the selected food may have been an available food that may have been determined as being similar to another type of food (e.g., that the user has previously enjoyed) for example as described herein, data describing that the user's past overall food selections have driven the selection, data that the food selection is a “surprise” selection for example as described herein, data that the food selection is based on another user, group of users, or user type that may be determined to be similar for example as described herein, and/or any other suitable data (e.g., for example as described herein).

In at least some exemplary embodiments, the exemplary disclosed system and method may use any desired utility function to evaluate different potential orders, such as, for example: Dietary targets (e.g., optimize items for balancing out a food grid, e.g., fruits and vegetables, carbs, dairy, protein, fats, and other criteria); and Food grouping (e.g., classify ingredients by flavor profile such as sweet, sour, salt, bitter, umami to target balancing a generated order by having targeted levels of each of these flavors). The exemplary disclosed system and method may also provide recommendations based on weather and/or event (e.g., in the case of poor or inclement weather, the exemplary disclosed system and method may increase a weighting of selection for “cozy” food such as ramen or soup, and if the weather is good or favorable, the exemplary disclosed system and method may increase the weighting of selection for “fresh” food such as salads and fruit)

In at least some exemplary embodiments, the exemplary disclosed system and method may also provide a “surprise” recommendation (e.g., based on input such as “Surprise me, I like samosa”). The “surprise” recommendation may be based on dish mapping and/or lineage of culture (e.g., or based on past feedback from a user). The exemplary disclosed system and method may also provide a “new” recommendation (e.g., based on input such as “I want to try a new cuisine” the recommendation engine may identify that the user has never tried Lebanese food and may suggest a menu accordingly). The “new” recommendation may be based on the user's order history.

The exemplary disclosed system and method may also pre-filter establishments (e.g., restaurants, grocery stores, online ordering, and/or any other suitable source for obtaining food) based on the overall rating of each establishment if desired, which could be sourced from an external party or inferred from on a user's historical actions and/or those of a user determined to be of a similar cohort (e.g., “similar” historical actions)

In at least some exemplary embodiments, the exemplary disclosed system and method may also provide a “never” option (e.g., user clicks “Never show me this” or “Never show me this again” for sushi, then this may get stored as something that the user wishes never to be recommended). Exclusion may extend to include similar or related items determined by the exemplary disclosed system and method.

In at least some exemplary embodiments, the exemplary disclosed system and method may provide pre-made weekly menus based on recommendations of other users of the system (e.g., “Lean protein menu” or “Try vegan for a month” menu). In at least some exemplary embodiments, the exemplary disclosed system and method may provide for sharing menus, feedback, and food or dish selections between different users or groups of users. For example, the exemplary disclosed system and method may use data of a given user (e.g., if allowed by the user) to share with other users or to use in making recommendations to other users and/or providing or refining food selection for other users. The exemplary disclosed system and method may identify relationships and similarities between users using techniques that may be similar to those described above regarding relationships and similarities between foods. For example, the exemplary disclosed system and method may use data of a first user profile to make a recommendation or a refinement of a food or dish selection for a second user profile that the exemplary disclosed system and method has determined to be similar to the first user profile (e.g., between users that the exemplary disclosed system and method has identified as having similar food tastes, users that use similar or the same establishments, users that live in similar geographic areas, and/or users that have any other suitable similar features or characteristics). For example, the exemplary disclosed system and method may determine similarities between users living in similar climate areas or zones though in different parts of the world (for example portions of California and the Mediterranean both have Mediterranean climates), similar levels of urban population density, and/or any other suitable features that may be similar and that may affect food (e.g., dish or cuisine) selections.

In at least some exemplary embodiments, the exemplary disclosed system and method may determine or refine proposed food (e.g., dish) selections based on geolocation and/or temporal criteria (e.g., factors or considerations). For example, the exemplary disclosed system and method may determine or refine proposed food selections for a given user based on what other users are ordering in proximity to or in the same geographical area (e.g., same city) as the given user and/or what other users are ordering at a same time or have ordered at a same time of day (e.g., brunch or later evening) as the given user.

The exemplary disclosed system and method may also vary or refine food ordering recommendations based on a hunger parameter including input such as “starving,” “very hungry,” “a little hungry,” or “I am peckish.”

In at least some exemplary embodiments, the exemplary disclosed system and method may introduce a sense of surprise and adventure to food ordering, remove decision fatigue from food ordering, and increase likelihood of repeat usage of the system and method.

The exemplary disclosed system and method may introduce standardization of food sections that may allow for a relatively simple mental model of food ordering by a user and allow for relatively easy comparisons between food ordering options (e.g., candidate orders).

In at least some exemplary embodiments, the exemplary disclosed system and method may avoid a situation in which a user is presented with an item that would dissuade a user from ordering from (e.g., turn that user off from) an establishment (e.g., based on pre-filtering of menu items). Based on this exemplary approach, the exemplary disclosed system and method may store portions of a full menu that the user was presented with and data regarding the outcome (e.g., user liked, user disliked, user thought that food was spicy, user thought this is a good order when very hungry, user thought this is a good order when not very hungry, and any other suitable data). Accordingly, the exemplary disclosed system and method may quickly and efficiently capture the “dislikes,” “likes,” and other data affecting food ordering for a user. The exemplary disclosed system and method may also store data such as a user's calorie intake and monetary limits, and take this data into consideration (e.g., as parameters) while generating a personalized menu in the exemplary processes described above.

In at least some exemplary embodiments, the exemplary disclosed system and method may provide an efficient and effective establishment (e.g., restaurants, grocery stores, online ordering, and/or any other suitable source for obtaining food) ordering application. The exemplary disclosed system and method may provide quick-order capabilities for use by a user (e.g., one click order), and personalized recommendations for food ordering (e.g., based on any suitable menu) for a user. The exemplary disclosed system and method may provide establishment users with new methods to promote dishes and opportunities to receive quick (e.g., real-time or near real-time) feedback on new menu ideas, and A/B testing metrics for new establishment menus. The exemplary disclosed system and method may also provide institutional users with increased opportunities for promoting establishments (e.g., restaurants, grocery stores, online ordering, and/or any other suitable source for obtaining food), and relatively quick convergence on client tastes and preferences by capturing steps (e.g., collecting data) in a decision flow that would otherwise be done in a user's mind. For example, institutional users that encompass areas such as food rating, establishment rating (e.g., restaurants, grocery stores, online ordering and/or other establishments), search engines, and any other suitable institutional users (e.g., Yelp, Grubhub, Uber Eats, restaurants, restaurant associations, government agencies, and/or any other suitable companies, organizations, associations, agencies, or authorities) may be provided with data by the exemplary disclosed system and method. For example, in addition to providing data of what users positively select or order, the exemplary disclosed system may provide such institutional users with additional data for example as described herein (e.g., food that is disliked by some or all users, never liked by some or all users, user preferences, etc.).

In at least some exemplary embodiments, the exemplary disclosed system and method may provide institutional users with data of predictions (e.g., use predictions and/or past selections) of user selections and behavior to help institutional users to make any suitable decisions and take any suitable actions associated with food selection and consumption. For example, the exemplary disclosed system and method may provide data for use by institutional users in managing inventory, supplies, and supply chain operations. The exemplary disclosed system and method may provide institutional users with data that may be useful in decision-making regarding pricing of food, health policy and disease control (e.g., alerts regarding potentially unsuitable food), supply chain management and shipping, food handling and inspection, human resource management (e.g., of food preparation, handling, and delivery personnel), food preparation training, and/or any other decision-making that may utilize data stored, processed, and/or provided by the exemplary disclosed system and method.

The exemplary disclosed system and method may be used in any suitable application for ordering or acquiring food. For example, the exemplary disclosed system and method may be used in any suitable application for ordering of food for delivery, ordering takeout food, visiting an establishment (e.g., recommending an order at a physical restaurant), grocery store shopping, online ordering, and/or any other suitable source for obtaining food.

FIG. 1 illustrates an exemplary operation and system of at least some exemplary embodiments of the present disclosure. Process 300 may begin at step 305. At step 305, order generation parameters may be inputted via any suitable user device for example as described herein. The order generation parameters may include any suitable parameters such as those similar to the exemplary disclosed criteria described herein. For example, the order generation parameters may include location, party details (e.g., party size and any other suitable data regarding a party), dietary criteria, and/or any other suitable criteria.

At step 310, the exemplary disclosed system and method may also receive, store, and/or process order generation parameters. Data such as account and prior order data created, stored, and processed by the exemplary disclosed system for example as described herein may be transferred and utilized in processing the order generation parameters at steps 305 and 310.

At step 315, the exemplary disclosed system and method may perform a localization operation. The exemplary disclosed system and method may identify establishments based on geographic criteria (e.g., that deliver to a location of the user and/or that are within a predetermined or user-provided distance of the user's location) for example using global positioning data and/or any other suitable data. The exemplary disclosed system and method may also filter establishments based on their hours of operation, reservation availability, seating capacity, and/or any other suitable criteria. Based on the localization, identification, and/or filtering at step 315, the exemplary disclosed system may determine a set of candidate establishments at step 320.

At step 325, the exemplary disclosed system and method may operate to select one establishment (e.g., or one or more establishments) from the set of candidate establishments determined at step 320. The exemplary disclosed system and method may utilize rating data in selecting the establishment. The rating data may include user history data (e.g., user ratings and/or data based on user-provided feedback), third party rating data (e.g., Yelp or Google reviews), overall user ratings of users using the exemplary disclosed system, data based on machine learning operations, and/or any other suitable rating data. At step 330, the exemplary disclosed system and method may identify and prepare data of the selected establishment for processing.

At step 335, the exemplary disclosed system and method may perform menu categorization and order synthesis. The menu categorization operation may include menu categorization similar to as described above, including for example formatting food (e.g., menu items) according to a standardized format. The order synthesis or generation operation may be similar to as described herein regarding FIG. 2.

At step 340, the exemplary disclosed system and method may determine a hypothetical order or set of hypothetical orders based on the menu categorization operation and/or order generation operation at step 335. The exemplary disclosed system and method may display the hypothetical order or set of hypothetical orders determined at steps 335 and 340 to a user via an exemplary disclosed user device or any other suitable technique at step 345.

FIG. 2 illustrates an exemplary operation of at least some exemplary embodiments of the present disclosure. Process 400 may begin at step 405. At step 405, the exemplary disclosed system and method may initiate input of a new hypothetical order (e.g., an empty or blank order) or an order having predetermined or pre-selected items. For example, the hypothetical order or set of hypothetical orders may include food previously selected at a given establishment or food similar to food previously selected at the given establishment.

At step 410, the exemplary disclosed system and method may evaluate whether the hypothetical order or set of hypothetical orders fulfills order completion criteria (e.g., predetermined criteria and/or criteria inputted by the user for example when prompted to confirm whether the hypothetical order or set of hypothetical orders is acceptable when displayed to the user for example as described at step 345). When the hypothetical order or set of hypothetical orders is a new order for example as described above regarding step 405, the exemplary disclosed system and method may determine at step 415 that the hypothetical order or set of hypothetical orders does not fulfill order completion criteria and the exemplary disclosed system and method may proceed to step 425.

At step 425, the exemplary disclosed system and method may identify and filter out food items that may eviscerate or breach order completion criteria discussed further below regarding step 410. For example at step 425, the exemplary system and method may filter out or remove food items (e.g., menu items) that do not meet the exemplary disclosed criteria described below regarding step 410. After removing any applicable items, the exemplary disclosed system and method may proceed to step 430.

At step 430, the exemplary disclosed system and method may change food (e.g., adjust or modify menu items) to provide a revised hypothetical order or set of hypothetical orders. For example, the exemplary disclosed system and method may shuffle items including randomly removing menu items and adding new menu items available from an establishment (e.g., removing and adding items substantially entirely randomly or by varying a single or a few parameters). The exemplary disclosed system and method may vary menu items by optimizing the hypothetical order or set of hypothetical orders to match desired macronutritional criteria and/or dietary balance criteria. The exemplary disclosed system and method may vary menu items to include previously-liked food (e.g., dishes) or food that may be similar to previously-liked food. The exemplary disclosed system and method may vary menu items to better fit or match a user's flavor profile for example as described herein. For example, the exemplary disclosed system and method may select food items available at an establishment that may be similar to foods that may match a user's flavor profile and/or that may be similar to foods on which a user's flavor profile is based. The exemplary disclosed system and method may remove and/or add new food items based on any suitable objective function that may provide a hypothetical order or set of hypothetical orders that may be determined to be “better” than the previous hypothetical order or set of hypothetical orders based for example on the criteria of step 410, a user's flavor profile, predicted user feedback, predicted probability that the user will select the order, and/or any other suitable criteria.

At step 435, the exemplary disclosed system and method may add or remove items to provide a revised hypothetical order or set of hypothetical orders based on the operation of step 430. The exemplary disclosed system and method may then return to step 410.

At step 410, the exemplary disclosed system and method may evaluate if the hypothetical order or set of hypothetical orders fulfills order completion criteria (e.g., predetermined criteria and/or criteria inputted by the user for example when prompted to confirm whether the hypothetical order or set of hypothetical orders is acceptable when displayed to the user for example at step 345). Completion criteria that may be determined as being fulfilled may include an order number of entrees equaling a target number of entrees, an order number of starters equaling a target number of starters, an order number of drinks equaling a target number of drinks, and/or an order number of desserts equaling a target number of desserts. Completion criteria that may be determined as being fulfilled may include a cost of an order (e.g., of the hypothetical order) being within a predetermined or user-inputted tolerance (e.g., +/−tolerance) of a target order cost or value. Completion criteria that may be determined as being fulfilled may include a total calorie count of an order being within a tolerance (e.g., +/−tolerance) of a target calorie count. Completion criteria may include any suitable order completion function that may be evaluated as true or false regarding a hypothetical order or a set of hypothetical orders.

The exemplary disclosed system and method may proceed from step 410 to step 415. If the exemplary disclosed system and method determines at step 415 that the hypothetical order or set of hypothetical orders again does not fulfill order completion criteria, the exemplary disclosed system and method returns to step 425. If the exemplary disclosed system and method determines at step 415 that the hypothetical order or set of hypothetical orders fulfills order completion criteria, the exemplary disclosed system and method proceeds to step 420. At step 420, the exemplary disclosed system and method may display the hypothetical order or set of hypothetical orders to the user as described in step 345. Process 400 may end at step 420.

FIG. 3 illustrates an exemplary operation of at least some exemplary embodiments of the present disclosure. Process 500 may begin at step 505. At step 510, the exemplary disclosed system and method may select an establishment based on user input provided via an exemplary disclosed user device, predetermined criteria, machine learning operations, and/or based on an operation of the exemplary disclosed algorithms. The exemplary disclosed system and method may then proceed to step 515.

At step 515, the exemplary disclosed system and method may generate a hypothetical order or set of hypothetical orders similarly to for example as described above regarding process 400. At step 520, the exemplary disclosed system and method may display the hypothetical order or set of hypothetical orders to a user for example as described above regarding steps 345 and 420. Also for example at step 520, the exemplary disclosed system and method may contact an establishment to place an order (e.g., with or without prompting a user) using the hypothetical order. For example, the exemplary disclosed system and method may electronically place an order (e.g., via a website or other platform) or automatically place a call to an establishment to place an order (e.g., via the user's mobile device). The exemplary disclosed system may use the hypothetical order in any suitable manner such as, for example, by automatically placing an order using the hypothetical order by any suitable technique (e.g., via cellular phone call or internet). The exemplary disclosed system and method may then proceed to step 525.

At step 525, the exemplary disclosed system and method may select a refinement action based on user input provided via an exemplary disclosed user device, predetermined criteria, machine learning operations, and/or based on an operation of the exemplary disclosed algorithms. The refinement action may include for example a user indicating a like or dislike, removing or adding a food item, “freezing” or “unfreezing” an item, changing an establishment, rejecting a type of food (e.g., spicy food), and/or any other suitable refinement action.

At step 530, the exemplary disclosed system and method may store any suitable data associated with process 500 such as, for example, a date and/or time, data of a hypothetical order or set of hypothetical orders, data of an action taken by the user and/or the user, and/or any other suitable data for adjustment of a short term or long term profile for example as described herein.

At step 535, the exemplary disclosed system and method may perform an action based on the operations of steps 510, 515, 520, and 525. For example, the exemplary disclosed system and method may return to step 515 to generate a hypothetical order or a set of hypothetical orders. The exemplary disclosed system and method may return to step 510 to select a new establishment or a same establishment. The exemplary disclosed system and method may also proceed to step 540 to freeze or unfreeze a food item, and then return to step 520. The exemplary disclosed system and method may continue iteratively as desired through the steps of process 500. The exemplary disclosed system and method may be performed by a single user and/or by a plurality of users (e.g., co-located users and/or remotely located users) using the system to collaboratively produce a hypothetical food order.

In at least some exemplary embodiments, the present disclosure may generally relate to a system and method for ordering food. The system and method may include an order generation process and an order refinement process. The order generation process may include sizing of an order and selecting items to constitute the order. The system and method may refine the generated order using the order refinement process. The system and method may incorporate a plurality of profiles for a given user, including a long-term profile storing long-term food ordering data and a short-term profile including short-term food ordering data.

In at least some exemplary embodiments, the exemplary disclosed system may include a food ordering module, comprising computer-executable code stored in non-volatile memory and a processor. The food ordering module and the processor may be configured to receive order generation input from a user, identify a plurality of establishments based on the order generation input, select an establishment from the plurality of establishments, transfer data of a menu of the establishment into a standardized menu format, generate a hypothetical food order based on the standardized menu format, and display the hypothetical food order to the user via a user device. The order generation input may exclude data of food type and food items. The hypothetical food order may include data of food type and food items. The order generation input may include at least one data selected from the group of location data, data of a number of people, data of dietary criteria including vegetarian status, and combinations thereof. The order generation input may exclude data of menu items. The hypothetical food order may include data of menu items. The plurality of establishments may include at least one establishment selected from the group of a restaurant, a grocery stores, an online food ordering platform, and combinations thereof. Generating the hypothetical food order may be based on data of a food item previously inputted by the user as a disliked food item in response to a previous hypothetical food order displayed to the user. The standardized menu format may be based on processing aggregate data of the plurality of establishments. Generating the hypothetical food order may be based on a flavor profile of the user that is based on data of food items previously inputted by the user as disliked food items in response to previous hypothetical food orders displayed to the user. The flavor profile may include a short-term flavor profile based on disliked food items for that day inputted previously that day and a long-term flavor profile based on long-term disliked food items.

In at least some exemplary embodiments, the exemplary disclosed method may include receiving order generation input, which may exclude data of food type and food items, from a user, identifying a plurality of establishments based on the order generation input, selecting an establishment from the plurality of establishments, transferring data of a menu of the establishment into a standardized menu format, generating a hypothetical food order based on the standardized menu format, and displaying the hypothetical food order, which includes data of food type and food items, to the user via a user device. The exemplary disclosed method may further include freezing data of at least one food item displayed to the user based on a freeze input provided by the user following displaying the hypothetical food order. The frozen data of the at least one food item may remain displayed to the user on subsequently displayed hypothetical food orders. The exemplary disclosed method may further include receiving input from the user to select and order the displayed hypothetical food order. The exemplary disclosed method may further include identifying a relationship between a first food item of a first cuisine type of the selected and ordered hypothetical food order and a second food item of a second cuisine type of the plurality of establishments. The first cuisine type may be different from the second cuisine type. The exemplary disclosed method may further include generating a subsequent hypothetical food order including the second food item based on the relationship identified between the first food item and the second food item. Generating the hypothetical food order may include at least one selected from the group of randomly shuffling food items, adding at least one food item similar to previously liked food items liked by the user, removing at least one food item similar to previously disliked food items, optimizing dietary balance, and combinations thereof. Generating the hypothetical food order may include determining if the hypothetical food order meets at least one criteria selected from the group of a number of ordered food items equaling a target number of food items, a cost of the hypothetical food order being within a predetermined tolerance of a target food order value, a calorie count of the hypothetical food order being within a predetermined tolerance of a target food order calorie count, and combinations thereof. The exemplary disclosed method may further include displaying, to the user via the user device, data of criteria used in generating the hypothetical food order including a primary reason for the hypothetical food order being selected for the user. The criteria may be selected from the group of a time of day of ordering, weather conditions, a food order liked by similar users, and combinations thereof.

In at least some exemplary embodiments, the exemplary disclosed system may include a food ordering module, comprising computer-executable code stored in non-volatile memory and a processor. The food ordering module and the processor may be configured to receive order generation input from a user, identify a plurality of establishments based on the order generation input, select an establishment from the plurality of establishments, transfer data of a menu of the establishment into a standardized menu format, generate a hypothetical food order based on the standardized menu format, and display the hypothetical food order to the user via a user device. Generating the hypothetical food order may include including one or more new food items that have not been displayed to the user before in previous hypothetical food orders. Generating the hypothetical food order may include excluding one or more food items similar to one or more disliked food items previously inputted by the user as disliked food items in response to the previous hypothetical food orders displayed to the user. The plurality of establishments may be establishments that have not been displayed to the user in previous hypothetical orders and that are located within a predetermined distance to the user.

The exemplary disclosed system and method may provide an efficient and effective technique for quickly narrowing down a large number of food options that may be available at a given food source such as a food provider website or establishment (e.g., restaurants, grocery stores, online ordering, and/or any other suitable source for obtaining food). The exemplary disclosed system and method may reduce or substantially eliminate choice paralysis by a user when making food ordering decisions. The exemplary disclosed system and method may also enhance satisfaction of food ordering, consumption, and dining by a user. The exemplary disclosed system and method may also provide surprise, excitement, or novelty to users in ordering food.

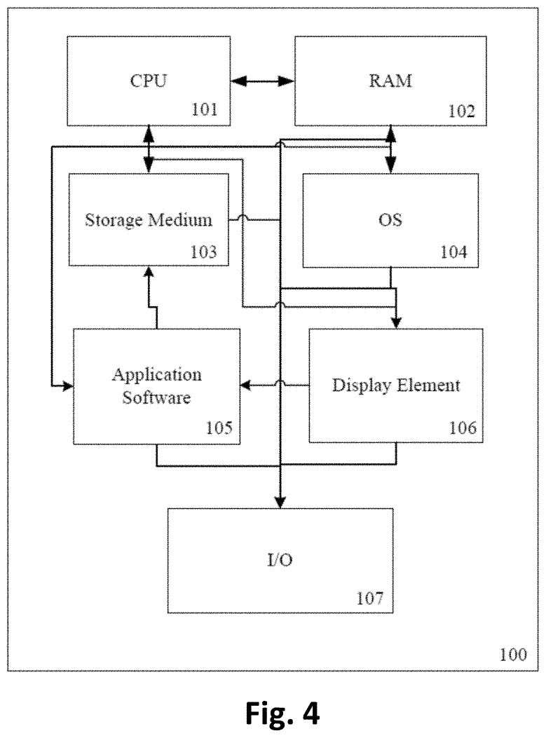

An illustrative representation of a computing device appropriate for use with embodiments of the system of the present disclosure is shown in FIG. 4. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

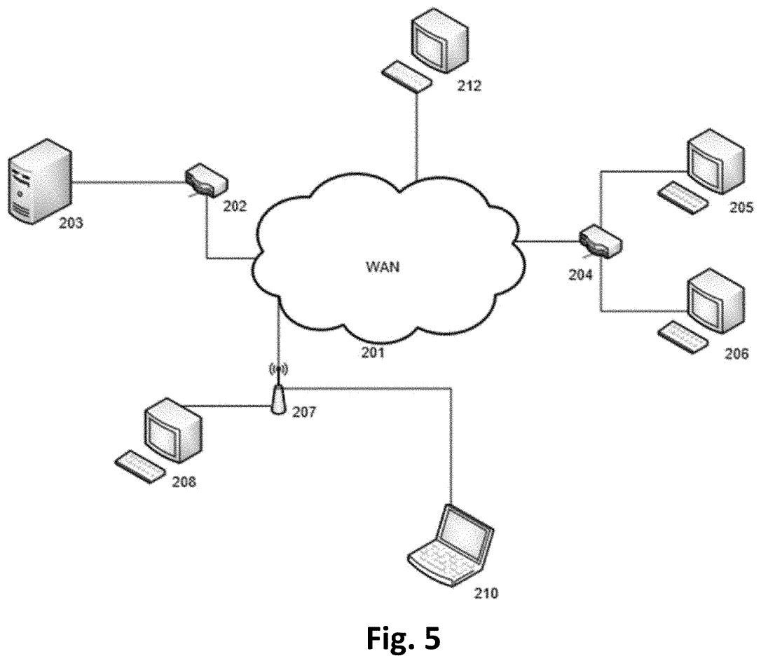

Various examples of such general-purpose multi-unit computer networks suitable for embodiments of the disclosure, their typical configuration and many standardized communication links are well known to one skilled in the art, as explained in more detail and illustrated by FIG. 5, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 5, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 5, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

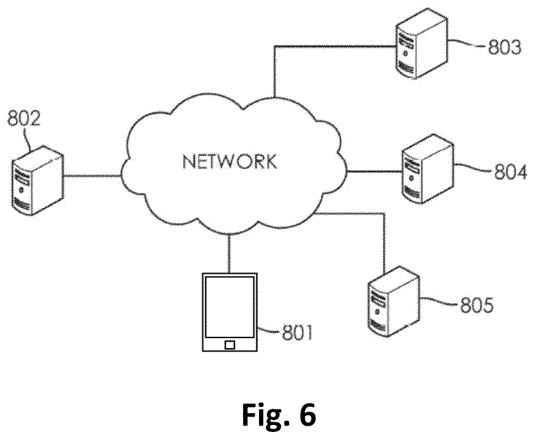

Turning now to FIG. 6, a continued schematic overview of a cloud-based system in accordance with an embodiment of the present invention is shown. In FIG. 6, the cloud-based system is shown as it may interact with users and other third party networks or APIs (e.g., APIs associated with the exemplary disclosed E-Ink displays). For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. The data store may also be a non-relational database. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A system, comprising:
a food ordering module, comprising computer-executable code stored in non-volatile memory; and
a processor;
wherein the food ordering module and the processor are configured to:
receive order generation input from a user;
identify a plurality of establishments based on the order generation input;
select an establishment from the plurality of establishments;
transfer data of a menu of the establishment into a standardized menu format;
generate a hypothetical food order based on the standardized menu format; and
display the hypothetical food order to the user via a user device.

2. The system of claim 1, wherein:
the order generation input excludes data of food type and food items; and
the hypothetical food order includes data of food type and food items.

3. The system of claim 1, wherein the order generation input includes at least one data selected from the group of location data, data of a number of people, data of dietary criteria including vegetarian status, and combinations thereof.

4. The system of claim 1, wherein:
the order generation input excludes data of menu items; and
the hypothetical food order includes data of menu items.

5. The system of claim 1, wherein the plurality of establishments includes at least one establishment selected from the group of a restaurant, a grocery stores, an online food ordering platform, and combinations thereof.

6. The system of claim 1, wherein generating the hypothetical food order is based on data of a food item previously inputted by the user as a disliked food item in response to a previous hypothetical food order displayed to the user, and wherein a plurality of identified food relationships are derived from menu item descriptions and order histories of at least one of the user and a plurality of other users.

7. The system of claim 1, wherein the standardized menu format is based on processing aggregate data of at least some of the plurality of establishments.

8. The system of claim 1, wherein generating the hypothetical food order is based on a flavor profile of the user that is based on data of food items previously inputted by the user as disliked food items in response to previous hypothetical food orders displayed to the user.

9. The system of claim 8, wherein the flavor profile includes a short-term flavor profile based on disliked food items for that day inputted previously that day and a long-term flavor profile based on long-term disliked food items.

10. A method, comprising:
receiving order generation input, which excludes data of food type and food items, from a user;
identifying a plurality of establishments based on the order generation input;
selecting an establishment from the plurality of establishments;
transferring data of a menu of the establishment into a standardized menu format;
generating a hypothetical food order based on the standardized menu format; and
displaying the hypothetical food order, which includes data of food type and food items, to the user via a user device.

11. The method of claim 10, further comprising freezing data of at least one food item displayed to the user based on a freeze input provided by the user following displaying the hypothetical food order; wherein the frozen data of the at least one food item remains displayed to the user on subsequently displayed hypothetical food orders.

12. The method of claim 10, further comprising receiving input from the user to select and order the displayed hypothetical food order.

13. The method of claim 12, further comprising identifying a relationship between a first food item of a first cuisine type of the selected and ordered hypothetical food order and a second food item of a second cuisine type of the plurality of establishments; wherein the first cuisine type is different from the second cuisine type.

14. The method of claim 13, further comprising generating a subsequent hypothetical food order including the second food item based on the relationship identified between the first food item and the second food item.

15. The method of claim 10, wherein generating the hypothetical food order includes at least one selected from the group of randomly shuffling food items, adding at least one food item similar to previously liked food items liked by the user, removing at least one food item similar to previously disliked food items, optimizing dietary balance, and combinations thereof.

16. The method of claim 10, wherein generating the hypothetical food order includes determining if the hypothetical food order meets at least one criteria selected from the group of a number of ordered food items equaling a target number of food items, a cost of the hypothetical food order being within a predetermined tolerance of a target food order value, a calorie count of the hypothetical food order being within a predetermined tolerance of a target food order calorie count, and combinations thereof.

17. The method of claim 10, further comprising displaying, to the user via the user device, data of criteria used in generating the hypothetical food order including a primary reason for the hypothetical food order being selected for the user; wherein the criteria are selected from the group of a time of day of ordering, weather conditions, a food order liked by similar users, and combinations thereof.

18. A system, comprising:
a food ordering module, comprising computer-executable code stored in non-volatile memory; and
a processor;
wherein the food ordering module and the processor are configured to:
receive order generation input from a user;
identify a plurality of establishments based on the order generation input;
select an establishment from the plurality of establishments;
transfer data of a menu of the establishment into a standardized menu format;
generate a hypothetical food order based on the standardized menu format; and
display the hypothetical food order to the user via a user device;
wherein generating the hypothetical food order includes including one or more new food items that have not been displayed to the user before in previous hypothetical food orders.

19. The system of claim 18, wherein generating the hypothetical food order includes excluding one or more food items similar to one or more disliked food items previously inputted by the user as disliked food items in response to the previous hypothetical food orders displayed to the user.

20. The system of claim 18, wherein the plurality of establishments are establishments that have not been displayed to the user in previous hypothetical orders and that are located within a predetermined distance to the user.
